(19) United States
(12) Patent Application Publication
(10) Pub. No.: US 2022/0228436 A1
(43) Pub. Date: Jul. 21, 2022

(54) INTELLIGENT DRIVING DEVICE AND ELECTRIC CURTAIN THEREOF

(71) Applicant: NINGBO SUNFREE MOTOR TECHNOLOGY COMPANY LIMITED, Ningbo (CN)

(72) Inventors: Chun JIANG, NINGBO (CN); Baoguo TAN, NINGBO (CN)

(21) Appl. No.: 17/359,582

(22) Filed: Jun. 27, 2021

(30) Foreign Application Priority Data
Jan. 15, 2021 (CN) 202110056776.5

(51) Int. Cl. E06B 9/70; E06B 9/42

(52) U.S. Cl. CPC E06B 9/70; E06B 2009/6809; E06B 9/42

(57) ABSTRACT

An intelligent driving device is provided which comprise a housing, and an end face of the housing is provided with a motor and a power source; the power source and the motor are arranged up and down in parallel, a main control board is disposed inside the housing, the motor and the power source both are electrically connected to the main control board, and the power source, the main control board and the motor are arranged into a U shape. In this case, the electric curtain will be made shorter and applicable to mounting in the spaces of various sizes. Thus, the small size can be guaranteed, and more intelligent chips can be disposed, thereby satisfying the intelligent development of the electric curtains.

### CROSS-REFERENCE TO RELATED APPLICATIONS

This application claims priority to Chinese Patent Application No. 202110056776.5 with a filing date of Jan. 15, 2021. The content of the aforementioned application, including any intervening amendments thereto, are incorporated herein by reference.

### TECHNICAL FIELD

The present invention relates to the technical field of electric curtains, and in particular to an intelligent driving device and an electric curtain thereof.

### BACKGROUND

Along with progress of science and technology and improvement of living level, the household products of people become more automatic and more intelligent. The traditional curtains are operated manually, for example, the pull bead curtains, shutter curtains and fabric curtains and the like are basically opened and closed by hand. Now, many electric curtains such as electric rolling curtains are available on the market. These electric curtains are driven to open and close by driving a motor to rotate a rolling tube. The conventional motor used by the electric rolling curtains are mostly tubular motor which is compact in structure and can be easily mounted into a rolling tube. However, the tubular motor is shaped like a straight tube and has a limited internal mounting space. Generally, a power source, a main control board, a motor and a speed reducer are mounted linearly inside the tubular motor. Due to limitation of parts mounted in the tubular motor, a length of the tubular motor cannot be too short. Further, along with the trend of the intelligent development, more intelligent chips are to be mounted inside the tubular motor. However, the tubular motor cannot have a larger mounting space due to its too small diameter, severely affecting the intelligent development of the electric curtains. Even if all these chips are mounted inside, the tubular motor will be lengthened, thereby affecting the entire length design of the electric curtain. Therefore, small-size curtains are not applicable to some small spaces such as skylight, toilet and storage room due to their lengths. In addition, a tubular motor usually has a metal housing which may shield signals. In this case, an end of the tubular motor will be provided with a stroke head in which a printed circuit board (PCB) is disposed, and the PCB board is connected with an internal main control board through a ribbon cable. Thus, the PCB board can receive the signals and exchange instructions with the main control board through the ribbon cable. Since it is required to mount the main control board and the PCB board, the number of mounted parts will be increased.

### SUMMARY

In order to solve the problems in the prior art, the present invention provides an intelligent driving device and an electric curtain thereof. The intelligent driving device comprises a motor, a main control board, and a power source arranged in a U shape, which shortens the entire length and further makes an electric curtain shorter. Thus, the electric curtain can be mounted in the spaces of various sizes. In this way, the small size can be guaranteed, and more intelligent chips can be disposed, thereby satisfying the intelligent development of the electric curtains.

A technical solution adopted by the present invention to solve the above technical problems is as follows: an intelligent driving device comprises a housing, and an end face of the housing is provided with a motor and a power source; the power source and the motor are arranged up and down in parallel, a main control board is disposed inside the housing, the motor and the power source both are electrically connected to the main control board, and the power source, the main control board and the motor are arranged in a U shape.

Further, a connection portion is convexly disposed at an end face of the housing, and a first mounting position into which the power source is inserted is disposed on the connection portion.

Further, a second mounting position is disposed above the first mounting position on the connection portion, and a functional module in electrical connection with the main control board is disposed inside the second mounting position.

Further, the functional module comprises a shell in which a control chip is disposed, and a control module with one or more motor control modes is integrated on the control chip.

Further, the control module is a wireless communication module or a wired communication module.

Further, the motor comprises an outer metal tube, a motor core, and a speed reducer, where the motor core and the speed reducer are mounted inside the outer metal tube, an output end of the motor core is in transmission connection with the speed reducer, the speed reducer is fixedly connected with the outer metal tube, one end of the outer metal tube is fixedly connected to the housing, and the motor core is in electrical connection with the main control board.

Further, the other end of the outer metal tube is provided with a driving head which is in transmission connection with an output end of the speed reducer.

Further, a detachable end cover is disposed at the other end face of the housing.

Further, a switch, an indicator lamp, a setting button, and a data interface are disposed on the main control board, and windows in one-to-one correspondence with the switch, the indicator lamp, the setting button and the data interface are opened on a side wall of the housing.

An electric curtain is provided, comprising a cross beam, a rolling tube, a curtain body, a connecting piece, and the intelligent driving device as described above. The cross beam and the rolling tube are arranged up and down in parallel, the connecting piece and the intelligent driving device are connected at both ends of the cross beam and the rolling tube respectively, the curtain body is wound on the rolling tube, and the motor is in transmission connection with the rolling tube.

Compared with the prior art, the present invention has the following advantages: the motor, the main control board and the power source are separately arranged into a U shape, which obviously shortens the entire length compared with the traditional straight tube shape design. That is, the basic length of the existing tubular motor at least comprises a sum of lengths of the power source, the motor and the main control board, whereas the basic length of the present invention only comprises the length of the power source or the motor. In this case, the electric curtain will be made shorter and applicable to mounting in the spaces of various sizes. Thus, the small size can be guaranteed, and more intelligent chips can be disposed, thereby satisfying the intelligent development of the electric curtains. Further, the main control board is disposed inside the housing so that the main control board is separated from the motor, thereby preventing the outer metal tube of the motor from shielding signals. Further, the main control board will have a larger mounting space, and the original externally-disposed PCB board and the main control board are integrated together, reducing the number of mounted parts.

An intelligent driving device is provided which comprise a housing, and an end face of the housing is provided with a motor and a power source; the power source and the motor are arranged up and down in parallel, a main control board is disposed inside the housing, the motor and the power source both are electrically connected to the main control board, and the power source, the main control board and the motor are arranged into a U shape. In the present invention, the motor, the main control board and the power source are separately arranged into a U shape, which obviously shortens the entire length compared with the traditional straight tube shape design. That is, the basic length of the existing tubular motor at least comprises a sum of lengths of the power source, the motor and the main control board, whereas the basic length of the present invention only comprises the length of the power source or the motor. In this case, the electric curtain will be made shorter and applicable to mounting in the spaces of various sizes. Thus, the small size can be guaranteed, and more intelligent chips can be disposed, thereby satisfying the intelligent development of the electric curtains. Further, the main control board is disposed inside the housing so that the main control board is separated from the motor, thereby preventing the outer metal tube of the motor from shielding signals and the main control board will have a larger mounting space.

### BRIEF DESCRIPTION OF THE DRAWINGS

In order to describe the embodiments of the present invention or the technical solution of the prior art more clearly, brief descriptions will be made below to the accompanying drawings involved in descriptions of the embodiments or the prior art. Obviously, the accompanying drawings are merely illustrative, and other drawing may also be obtained by those skilled in the art based on theses drawings without paying creative work.

The structures, scales, sizes and the like depicted in the specification are only used by those skilled in the art to know and read the contents disclosed by the specification rather than to limit the embodiments of the present disclosure. Therefore, the structures, scales, sizes and the like do not have technically substantive meanings. Any modification, changes or adjustment to the structures, the scales and sizes shall all fall within the scope of protection covered by the technical contents disclosed by the present invention without affecting the effects and the purposes achieved by the present invention.

FIG. 1 is a front view of a tubular motor in the prior art.

FIG. 2 is a front view of the present invention.

FIG. 3 is a structural schematic diagram of the present invention.

FIG. 4 is a structural schematic diagram of the present invention without a housing.

FIG. 5 is a structural schematic diagram of dismounting of an end cover according to an embodiment of the present invention.

FIG. 6 is a structural schematic diagram of a functional module according to an embodiment of the present invention.

FIG. 7 is an exploded view of a functional module according to an embodiment of the present invention.

FIG. 8 is an exploded view of a motor according to an embodiment of the present invention.

FIG. 9 is a structural schematic diagram of mating of a motor and a main control board according to an embodiment of the present invention.

FIG. 10 is a structural schematic diagram of an electric curtain according to an embodiment of the present invention.

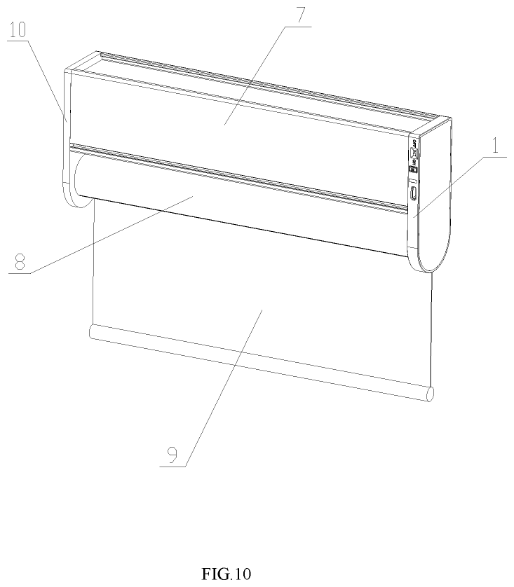

Numerals of the drawings are described as follows: 1—housing, 1.1—first mounting position, 1.2—second mounting position, 1.3—end cover, 2—motor, 2.1—outer metal tube, 2.2—motor core, 2.3—speed reducer, 2.4—signal magnet, 3—power source, 4—main control board, 4.1—switch, 4.2—indicator lamp, 4.3—setting button, 4.4—data interface, 4.5—Hall sensor, 5—functional module, 5.1—shell, 5.2—control chip, 5.3—control module, 6—driving head, 7—cross beam, 8—rolling tube, 9—curtain body, 10—connecting piece.

### EMBODIMENTS

The present invention will be further described below in combination with the specific embodiments.

In the descriptions of the present invention, it is understood that orientation or positional relationship indicated by the terms such as “central”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, “axial”, “radial”, and “circumferential” is used only for ease of descriptions and simplification of descriptions and does not indicate or imply that the indicated devices or elements must have a particular orientation, or be constructed or operated in a particular orientation. Therefore, such terms shall not be understood as limiting of the present invention.

Further, the terms “first” and “second” are used for descriptions only and shall not be understood as indicating or implying relative importance or implicitly indicating the number of the indicated features. As a result, the features defined by “first” and “second” may explicitly or implicitly comprise at least one feature. In the descriptions of the present invention, “several” has at least two meanings, for example, two or three or the like, unless otherwise clearly stated.

In the present invention, unless otherwise clearly stated or defined, the terms “mount”, “connect”, “couple”, and “fix” and the like shall be understood in a broad sense, for example, may be fixed connection, or detachable connection, or formed into one piece; or may be mechanical connection, or electrical connection; or direct connection or indirect connection through an intermediate medium, or may be internal communication between two elements or mutual interaction of two elements, unless otherwise stated. Those skilled in the art may understand the specific meanings of the above terms in the present invention according to actual situations.

In the present invention, unless otherwise clearly stated or defined, the first feature being “on” or “below” the second feature refers to that the first feature and the second feature are in direct contact, or the first feature and the second feature are in indirect contact through an intermediate medium. Furthermore, the first feature being “above” or “on” the second feature refers to that the first feature is exactly above or obliquely above the second feature, or only refers to that the first feature has a higher horizontal height than the second feature. The first feature being “under” or “below” the second feature refers to that the first feature is exactly under or obliquely below the second feature, or only refers to that the first feature has a smaller horizontal height than the second feature.

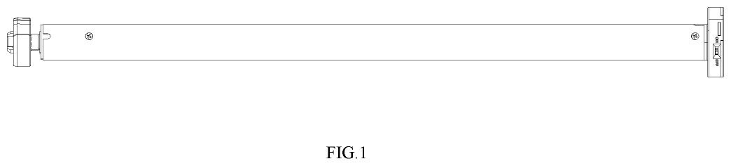

FIG. 1 is a front view of a tubular motor in the prior art. In general, a power source, a main control board, a motor and a speed reducer arranged linearly are mounted inside the tubular motor. Due to the limitation of the parts mounted inside the tubular motor, a length of the tubular motor cannot be too short. Thus, the entire length design of a curtain will be affected, and small-size curtains will not be applicable to small spaces such as skylight, toilet, and storage room.

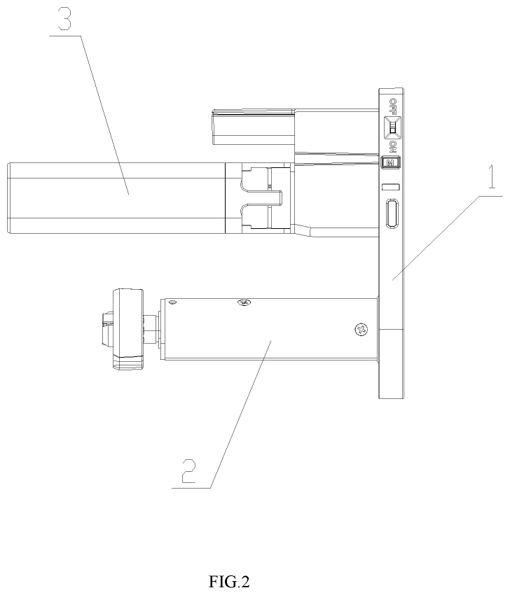

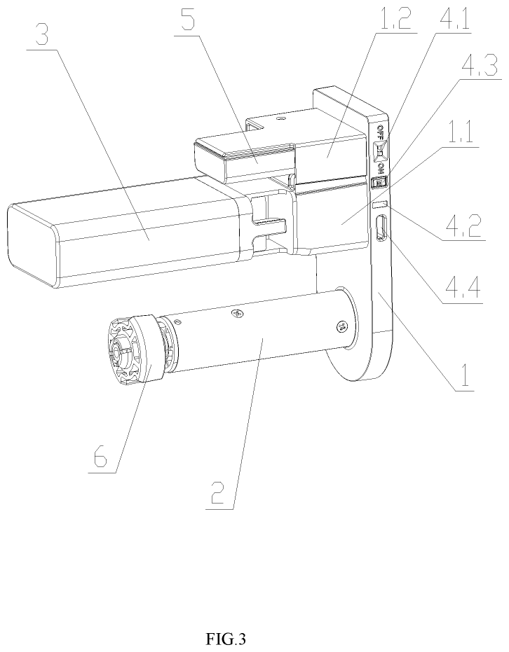

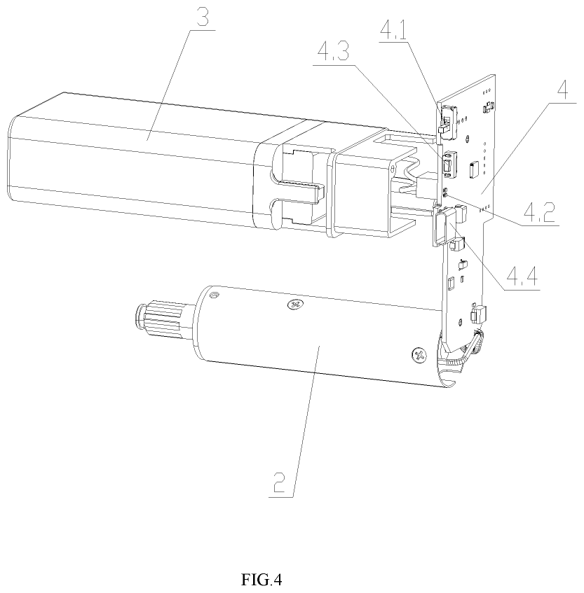

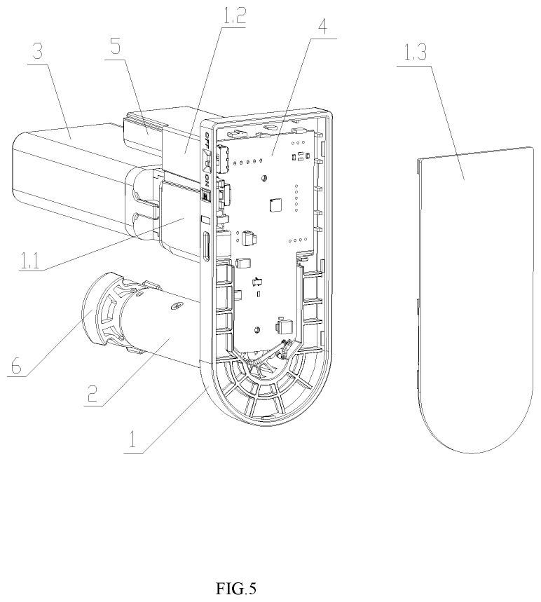

As shown in FIGS. 2-5, the present invention provides an intelligent driving device, comprising a housing 1, where the housing is shaped like a vertical flat plate with a small thickness, the housing 1 is made of plastic which will not shield signals, a motor 2 and a power source 3 are disposed at an end face of the housing 1, the power source 3 and the motor 2 are arranged up and down in parallel, a main control board 4 is disposed inside the housing 1, the motor 2 and the power source 3 are in electrical connection with the main control board 4, and the power source 3, the main control board 4 and the motor 2 are arranged in a U shape.

In the present invention, the motor 2, the main control board 4 and the power source 3 are separately arranged into a U shape, which obviously shortens the entire length compared with the traditional straight tube shape design. That is, the basic length of the existing tubular motor at least comprises a sum of lengths of the power source, the motor and the main control board, whereas the basic length of the present invention only comprises the length of the power source 3 or the motor 2. In this case, the electric curtain will be made shorter and applicable to mounting in the spaces of various sizes. Thus, the small size can be guaranteed, and more intelligent chips can be disposed, thereby satisfying the intelligent development of the electric curtains. Further, the main control board 4 is disposed inside the housing 1 so that the main control board 4 is separated from the motor 2, thereby preventing an outer metal tube 2.1 of the motor 2 from shielding signals. Further, the main control board 4 will have a larger mounting space, and the original externally-disposed PCB board and the main control board are integrated together, reducing the number of mounted parts.

A connection portion is convexly disposed at an end face of the housing 1, and a first mounting position 1.1 into which the power source 3 is inserted is disposed on the connection portion. The first mounting position 1.1 is in communication with the interior of the housing 1 to facilitate electrical connection of the power source 3 and the main control board 4 for power supply. After the power source 3 is inserted into the first mounting position 1.1, the power source 3 is perpendicular to the main control board 4. This structural disposal not only shortens the entire length but also facilitates subsequent assembly of an electric curtain.

A second mounting position 1.2 is disposed above the first mounting position 1.1 on the connection portion, and a functional module 5 in electrical connection with the main control board 4 is disposed inside the second mounting position 1.2. The second mounting position 1.2 is in communication with the interior of the housing 1 to facilitate electrical connection of the functional module 5 and the main control board 4 for information exchange. Further, after the functional module 5 is inserted into the second mounting position 1.2, the functional module 5 is perpendicular to the main control board 4. This structural disposal facilitates subsequent assembly of the electric curtain.

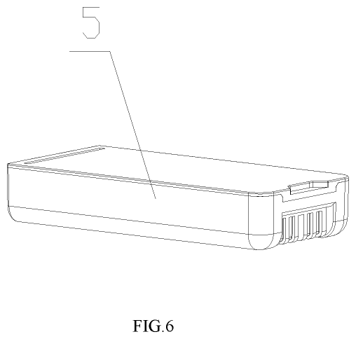

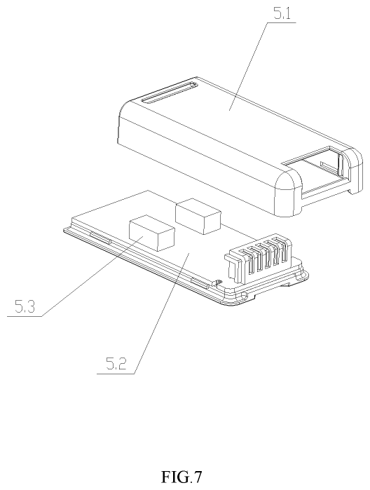

The disposal of the functional module 5 makes the driving device become more intelligent and achieve more intelligent operations. As shown in FIGS. 6-7, the functional module 5 comprises a shell 5.1 in which a control chip 5.2 is disposed. The control chip 5.2 is in electrical connection with the main control board 4. A control module 5.3 with one or more motor control modes is integrated on the control chip 5.2. The control module 5.3 is a wireless communication module or a wired communication module. The wireless communication module is a 433 MHZ radiofrequency module or an 868 MHZ radiofrequency module, or a wifi module, or a Bluetooth module, or a zigbee module, or a Z-wave module, or a Can communication module. The wired communication module is a dry contact module, or a strong current communication module, or a 485 communication module, or a KNX communication module, or a TCP/IP communication module. Therefore, a user may select a functional module 5 with a different function according to actual requirements and then replace the functional module 5 like replacing a battery due to ease of mounting and dismounting. An external control device may be connected with the functional module 5 in a wireless or wired manner. When the external control device is a mobile phone, or a remote controller or the like, the user may input a control instruction by the external control device, the control instruction is processed by the functional module 5 and sent to the main control board 5, and the main control board controls the motor 2 to run.

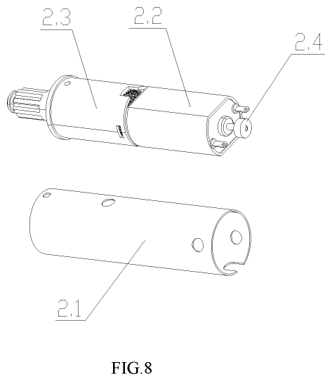

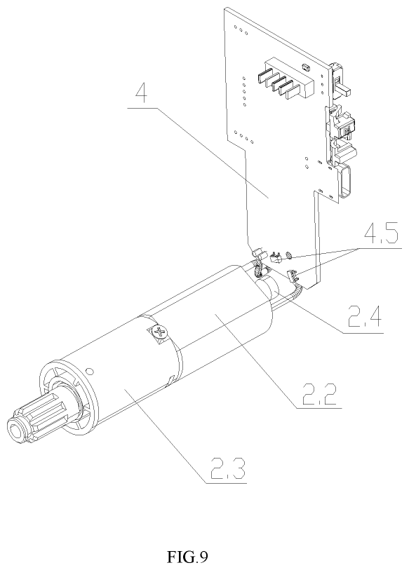

As shown in FIG. 8, the motor 2 comprises an outer metal tube 2.1, a motor core 2.2 and a speed reducer 2.3, where the motor core 2.2 and the speed reducer 2.3 are mounted inside the outer metal tube 2.1. An output end of the motor core 2.2 is in transmission connection with the speed reducer 2.3. The disposal of the speed reducer 2.3 makes the motor 2 run more stably. The speed reducer 2.3 and the outer metal tube 2.1 are fixedly connected, and an end of the outer metal tube 2.1 is fixedly connected to the housing 1. The motor core 2.2 is in electrical connection with the main control board 4. After the motor 2 and the housing 1 are assembled, the motor 2 is perpendicular to the main control board 4. This structural disposal not only shortens the entire length, but also facilitates subsequent assembly of the electric curtain. The other end of the outer metal tube 2.1 is provided with a driving head 6 in transmission connection with an output end of the speed reducer 2.3. The disposal of the driving head 6 aims to drive a rolling tube 8 as shown in FIG. 9. An end of the motor core 2.2 opposite to the output end is provided with a signal magnet 2.4. A Hall sensor 4.5 mated with the signal magnet 2.4 is disposed at a position that is on the main control board 4 and close to the signal magnet 2.4. When the motor 2 works, the signal magnet 2.4 and the output end of the motor core 2.2 rotate coaxially, and the Hall sensor 4.5 senses a number of turns that the motor 2 rotates through the rotation of the signal magnet 2.4. Compared with the prior art in which a Hall plate and a signal magnet are directly mounted at an end of the motor core, the structural disposal is simpler. In this structural disposal, the Hall sensor 4.5 is directly combined into the main control board 4 without mounting the Hall plate, and the Hall plate, the PCB board and the main control board are all directly combined into one main control board without electrical connection of the Hall plate and the main control board. Therefore, the assembly structure is simpler, the parts are fewer and the assembly efficiency is higher.

A detachable end cover 1.3 is disposed at the other end face of the housing 1. The disposal of the end cover 1.3 facilitates mounting and dismounting the main control board 4 in the housing 1. Further, after the end cover 1.3 is fitted with the housing 1, limiting protection will be provided to the main control board 4.

A switch 4.1, an indicator lamp 4.2, a setting button 4.3 and a data interface 4.4 are disposed on the main control board 4, and windows in one-to-one correspondence with the switch 4.1, the indicator lamp 4.2, the setting button 4.3 and the data interface 4.4 are opened on a side wall of the housing 1. Preferably, the data interface 4.4 may be a USB interface, which can be used for charging, plugging or data communication; the setting button 4.3 may be used for code pairing, switching, and resetting; the switch 4.1 is used to switch on or off the power source; and the indicator lamp 4.2 is used to display a working state.

A plate-carried antenna may also be integrated on the main control board 4 to receive a remote control signal, and its entire mounting structure is simpler and more orderly compared with a traditional antenna.

The main control board 4 adopted in the present invention is a microcontroller unit (MCU) board. Intelligent devices may be integrated onto the main control board 4 according to the market demands.

As shown in FIG. 9, another object of the present invention is to provide an electric curtain, comprising a cross beam 7, a rolling tube 8, a curtain body 9, a connecting piece, and the above intelligent driving device. The cross beam 7 and the rolling tube 8 are arranged up and down in parallel, the connecting piece 10 and the intelligent driving device are connected to both ends of the cross beam 7 and the rolling tube 8 respectively, the curtain body 9 is wound on the rolling tube 8, and the motor 2 is in transmission connection with the rolling tube 8. The rolling tube 8 is driven by the motor 2 to rotate so as to roll or unroll the curtain body 9, thereby realizing opening and closing of the curtain. The cross beam 7 comprises at least one mounting groove (not shown). Preferably, two mounting grooves are disposed up and down, where the upper mounting groove is used to receive the functional module 5, and the lower mounting groove is used to receive the power source 3. The structure of the connecting piece 10 may be adaptively changed according to the structural change of the cross beam 7. The mounting groove may penetrate through or not penetrate through the cross beam 7. In an actual use, a cross beam 7 with an appropriate length may be selected according to the size of the mounting space. The working process of the electric curtain is a conventional process of rolling and unrolling the curtain body 9 and thus will not be redundantly described herein.

The materials, reagents and experimental devices involved in the embodiments of the present invention will be commercially available products in the electric curtain field unless otherwise specified.

Finally, it is to be pointed out that the above embodiments are merely used to describe the technical solution of the present invention rather than limit the present invention. Although detailed descriptions are made to the present invention by referring to the preceding embodiments, those skilled in the art should understand that the technical solutions recorded in the above embodiments may be modified or part of technical features thereof may be equivalently substituted. Such modifications or substitutions will not cause the essences of the corresponding technical solutions to depart from the spirits and scopes of the technical solutions of various embodiments of the present invention.

1. An intelligent driving device, wherein it comprises a housing (1), and an end face of the housing (1) is provided with a motor (2) and a power source (3); the power source (3) and the motor (2) are arranged up and down in parallel, and a main control board (4) is disposed inside the housing (1), the motor (2) and the power source (3) both are electrically connected to the main control board (4), and the power source (3), the main control board (4) and the motor (2) are arranged into a U shape.

2. The intelligent driving device of claim 1, wherein a connection portion is convexly disposed at an end face of the housing (1), and a first mounting position (1.1) into which the power source (3) is inserted is disposed on the connection portion.

3. The intelligent driving device of claim 2, wherein a second mounting position (1.2) is disposed above the first mounting position (1.1) on the connection portion, and a functional module (5) in electrical connection with the main control board (4) is disposed inside the second mounting position (1.2).

4. The intelligent driving device of claim 3, wherein the functional module (5) comprises a shell (5.1) in which a control chip (5.2) is disposed, and a control module (5.3) with one or more motor control modes is integrated on the control chip (5.2).

5. The intelligent driving device of claim 4, wherein the control module (5.3) is a wireless communication module or a wired communication module.

6. The intelligent driving device of claim 1, wherein the motor (2) comprises an outer metal tube (2.1), and a motor core (2.2) and a speed reducer (2.3) are mounted inside the outer metal tube (2.1); an output end of the motor core (2.2) is in transmission connection with the speed reducer (2.3), the speed reducer (2.3) is fixedly connected with the outer metal tube (2.1), one end of the outer metal tube (2.1) is fixedly connected to the housing (1), and the motor core (2.2) is in electrical connection with the main control board (4).

7. The intelligent driving device of claim 6, wherein the other end of the outer metal tube (2.1) is provided with a driving head (6); an output end of the speed reducer (2.3) is in transmission connection with the driving head (6).

8. The intelligent driving device of claim 1, wherein a detachable end cover (1.3) is disposed at the other end face of the housing (1).

9. The intelligent driving device of claim 1, wherein a switch (4.1), an indicator lamp (4.2), a setting button (4.3), and a data interface (4.4) are disposed on the main control board (4), and windows in one-to-one correspondence with the switch (4.1), the indicator lamp (4.2), the setting button (4.3) and the data interface (4.4) are opened on a side wall of the housing (1).

10. An electric curtain, wherein it comprises a cross beam (7), a rolling tube (8), a curtain body (9), a connecting piece (10), and the intelligent driving device of claim 1; the cross beam (7) and the rolling tube (8) are arranged up and down in parallel, and the connecting piece (10) and the intelligent driving device are connected at both ends of the cross beam (7) and the rolling tube (8) respectively; the curtain body (9) is wound on the rolling tube (8), and the motor (2) is in transmission connection with the rolling tube (8).
